(19) United States
(12) Patent Application Publication
(10) Pub. No.: US 2015/0075109 A1
(43) Pub. Date: Mar. 19, 2015

(54) DECORATIVE FOLDABLE FRAME, DECORATIVE FOLDABLE FRAME ASSEMBLY AND DECORATIVE FOLDABLE MEMBER

(71) Applicant: Louis BERGEVIN, Notre-Dame de I'Ile Perrot (CA)

(72) Inventors: Louis Bergevin, Notre-Dame de l'Ile Perrot (CA); David Bergevin, Notre-Dame de l'Ile Perrot (CA); Charles Bergevin, Notre-Dame de l'Ile Perrot (CA); Philippe Bergevin, Notre-Dame de l'Ile Perrot (CA)

(21) Appl. No.: 14/395,620

(22) PCT Filed: Apr. 19, 2013
(86) PCT No.: PCT/CA2013/000396

§ 371 Date: Oct. 20, 2014

Related U.S. Application Data
(60) Provisional application No. 61/636,129, filed on Apr. 20, 2012.
(60) Provisional application No. 61/760,384, filed on Feb. 4, 2013.

(51) Int. Cl. E06B 1/34; E06B 1/52; E06B 1/36

(52) U.S. Cl. CPC E06B 1/34; E06B 1/345; E06B 1/347; E06B 1/36; E06B 1/52
USPC 52/656.2

(57) ABSTRACT

The present document describes a decorative foldable frame for interfacing with a surface defining an internal surface and a peripheral external surface, the decorative foldable frame comprising: an internal mounting element having an internal mounting surface for interfacing with the internal surface and an external surface, the internal mounting element defining a first end and a second end; at least two external mounting elements adjacent to each one of the first and second ends of the internal mounting element, each one of the at least two external mounting elements having an internal mounting surface for interfacing with the peripheral external surface and an external surface; and a foldable layer covering at least one of: the internal mounting surface and the external surface of the internal mounting element or the at least two external mounting elements; wherein the foldable layer is integrally formed for allowing the decorative foldable frame to fold and unfold to adopt any position between a non-installed position and an interfacing position.

### CROSS-REFERENCE TO RELATED APPLICATIONS

This application claims priority of U.S. provisional patent application Nos. 61/636,129 and 61/760,384 filed respectively on Apr. 20, 2012 and on Feb. 4, 2013.

### BACKGROUND

(a) Field

The subject matter disclosed generally relates to the field of building materials and to door and windows decorative elements. More particularly, the subject matter relates to decorative foldable frames, to decorative foldable frame assemblies, to decorative foldable members and to methods for installing and/or using the same.

(b) Related Prior Art

The assembly of door and window building materials is a challenging endeavour which is facilitated by specialized machinery and tools in industrial and manufacturing settings. However, such assembly remains difficult when performed in a household setting, especially by non-professional individuals.

There is therefore still a need in the field of door building materials for decorative foldable frames, decorative foldable frame assemblies, decorative foldable door members and methods for installing and/or using the same.

### SUMMARY

According to an embodiment, there is provided a decorative foldable frame for interfacing with a surface defining an internal surface and a peripheral external surface, the decorative foldable frame comprising: an internal mounting element having an internal mounting surface for interfacing with the internal surface and an external surface, the internal mounting element defining a first end and a second end; at least two external mounting elements adjacent to each one of the first and second ends of the internal mounting element, each one of the at least two external mounting elements having an internal mounting surface for interfacing with the peripheral external surface and an external surface; and a foldable layer covering at least one of: the internal mounting surface and the external surface of the internal mounting element or the at least two external mounting elements; wherein the foldable layer is integrally formed for allowing the decorative foldable frame to fold and unfold to adopt any position between a non-installed position and an interfacing position.

The internal mounting element may comprise a first internal mounting element and a second internal mounting element, each one of the first and second internal mounting elements defining a first end and a second end opposed to the first end, the first end of the first internal mounting element further comprises a mating connector releasably connected with a corresponding mating connector on the second end of the second internal mounting element.

The internal mounting element may define a longitudinal edge and wherein at least one of the external mounting elements defines a corresponding edge for interfacing with the longitudinal edge of the internal mounting element when the decorative foldable frame adopts the interfacing position.

The longitudinal edge may define a first longitudinal edge at the first end of the internal mounting element and a second longitudinal edge at the second end of internal mounting element and further wherein two external mounting elements define a first corresponding edge for interfacing with the first longitudinal edge of the internal mounting element and a second corresponding edge for interfacing with the second longitudinal edge of the internal mounting element when the decorative foldable frame adopts the interfacing position.

The first longitudinal edge and the second longitudinal edge of the internal mounting element may comprise a 45° longitudinal edge.

The first corresponding edge of a first one of the two external mounting elements and the second corresponding edge of a second one of the two external mounting elements may comprise a corresponding 45° longitudinal edge for interfacing with the first and second longitudinal edges of the internal mounting element when the decorative foldable frame adopts the fixedly interfacing position.

The internal mounting element may interact with the at least two external mounting elements for creating a 90° angle.

The internal mounting element and the at least two external mounting elements may comprise one of: a medium-density fiberboard material, a low-density fiberboard material, a high-density fiberboard material, a particle board, a wood material, a metallic material, a polymeric material and any combination thereof.

The foldable layer may comprise a thermoplastic material, a plastic material, a polymeric material, a metallic material, a linerboard material and any combination thereof.

The foldable layer may cover the internal mounting surface of the internal mounting element and the at least two external mounting elements.

The foldable layer may partially cover the internal mounting surface of the internal mounting element and the at least two external mounting elements.

The foldable layer may cover the external surface of the internal mounting element and the at least two external mounting elements.

The foldable layer may partially cover the external surface of the internal mounting element and the at least two external mounting elements.

The foldable layer may further include at least one foldable projection portion outwardly extending from the foldable layer.

According to another embodiment, there is provided a decorative foldable member comprising: an internal mounting element defining an internal interfacing surface, a first longitudinal end, a second longitudinal end and an external surface; two external mounting elements, each one of the two external mounting elements being adjacent to the first and second longitudinal ends respectively of the internal mounting element, each one of the two external mounting elements defining an external surface and an internal interfacing surface, an interfacing surface of one of the two external mounting elements for interfacing with the internal interfacing surface of the other one of the two external mounting element; and a foldable layer covering at least one of: the internal interfacing surface and the external surface of the internal mounting element or the two external mounting elements; wherein the foldable layer is integrally formed for allowing the decorative foldable member to fold and unfold to adopt any position between a non-interfacing position and an interfacing position.

When adopting the interfacing position, the internal interfacing surfaces of the two external mounting elements may be interfacing for creating a mating connector at a distal end of the decorative foldable member to receive at least one corresponding mating connector of another member.

The internal interfacing surface of the internal mounting element may comprise a first internal interfacing surface and a second internal interfacing surface adjacent to the first internal interfacing surface.

The two external mounting elements may define a first corresponding edge on one of the two external mounting elements for totally interfacing with the first internal interfacing surface of the internal mounting element and a second corresponding edge on the other one of the two external mounting elements for interfacing with the second interfacing surface of the internal mounting element when the decorative foldable member adopts the interfacing position.

The first internal interfacing surface and the second internal interfacing surface may each define a 45° longitudinal edge.

The first and second internal interfacing surfaces of the internal mounting element may comprise a 45° longitudinal edge for interfacing with the first and second corresponding edges of the two external mounting elements.

The internal mounting element may interact with the two external mounting elements for creating 90° angles.

The foldable layer may cover or partially cover the internal interfacing surface of the internal mounting element and the two external mounting elements.

The foldable layer may cover or partially cover the external surface of the internal mounting element and the two external mounting elements.

The foldable layer may further include at least one foldable fin outwardly extending from the foldable layer.

The mating connector may further comprise a compartment for receiving a liquid composition.

According to another embodiment, the foldable frame assembly for interfacing with a surface along a wall opening periphery, the surface defining an internal surface and a peripheral external surface, the foldable frame assembly comprising: a first decorative foldable frame; a second decorative foldable frame, the second decorative foldable frame extending from the first decorative foldable frame; and a third decorative foldable frame, the third decorative foldable frame extending from the second decorative foldable frame.

The foldable frame assembly may further comprise a fourth decorative foldable frame, the fourth decorative foldable frame perpendicularly extending from the third and the first decorative foldable frames.

The internal mounting element and the at least two external mounting elements comprise one of: a medium-density fiberboard material, a low-density fiberboard material, a high-density fiberboard material, a particle board, a wood material, a metallic material, a polymeric material and any combination thereof.

The foldable layer may comprise a thermoplastic material, a plastic material, a polymeric material, a metallic material, a linerboard material and any combination thereof.

The foldable layer may cover the internal mounting surface of the internal mounting element and the at least two external mounting elements.

The foldable layer may partially cover the internal mounting surface of the internal mounting element and the at least two external mounting elements.

The foldable layer may cover the external surface of the internal mounting element and the at least two external mounting elements.

The foldable layer partially may cover the external surface of the internal mounting element and the at least two external mounting elements.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 are perspective and top views of a door opening defined by a wall in accordance with an embodiment;

FIG. 2 is a side elevation view of a decorative foldable door frame in a non-installed position in accordance with another embodiment;

FIG. 3 is a top plan view of an internal mounting element and an adjacent external mounting element of the decorative foldable door frame of FIG. 2;

FIG. 4 is a top plan view of an internal mounting element and an adjacent external mounting element of the decorative foldable door frame of FIG. 2;

FIG. 5 is a top plan view of the decorative foldable door frame of FIG. 2 in an interfacing position around an opening defined by a wall;

FIG. 6 is a perspective view of a decorative foldable door member in an interfacing position in accordance with another embodiment and a close-up fragmentary view of an end of the decorative foldable door member;

FIG. 7 is a perspective exploded view of a decorative door showing the decorative foldable door member of FIG. 6 in accordance with another embodiment;

FIG. 8 is an elevation view of the decorative foldable door member of FIG. 6 in a non-interfacing position;

FIG. 9 is an elevation view of the decorative foldable door member of FIG. 6 in an interfacing position;

FIG. 10 is a perspective view of a foldable door frame assembly in its non-installed position in accordance with another embodiment;

FIG. 11 is another perspective view of the foldable door frame assembly of FIG. 9 in its non-installed position;

FIG. 12 is a perspective view of the foldable door frame assembly of FIG. 9 in its interfacing position;

FIG. 13 is another perspective view of the foldable door frame assembly of FIG. 9 in its non-installed position;

FIG. 14A is a perspective view of the foldable door frame assembly of FIG. 9 in its non-installed position to be installed on a door opening;

FIG. 14B is a perspective view of the foldable door frame assembly of FIG. 9 in a partially interfacing and extended position interfacing with the door opening;

FIG. 14C is a perspective view of the foldable frame assembly of FIG. 9 in an interfacing and extended position interfacing with the door opening;

FIG. 14D is a perspective view of the foldable door frame assembly of FIG. 9 in an interfacing position and unextended position interfacing with the door opening;

FIG. 15A is a side elevation view of a decorative foldable door frame in a non-installed position in accordance with another embodiment;

FIG. 15B is another side elevation view of the decorative foldable door frame of FIG. 15A in a non-installed position in accordance with another embodiment;

FIG. 15C is another side elevation view of the decorative foldable door frame of FIG. 15A in a non-installed position in accordance with another embodiment;

FIG. 15D is another side elevation view of the decorative foldable door frame of FIG. 15A in a non-installed position, where the mating connectors are releasably connected; and

FIG. 16 is a side elevation view of the decorative foldable door frame of FIGS. 15A-15D in an installed position in accordance with another embodiment.

It will be noted that throughout the appended drawings, like features are identified by like reference numerals.

### DETAILED DESCRIPTION

In embodiments, there are disclosed decorative foldable frames, decorative foldable frame assemblies, decorative foldable door members and methods for installing and/or using the same.

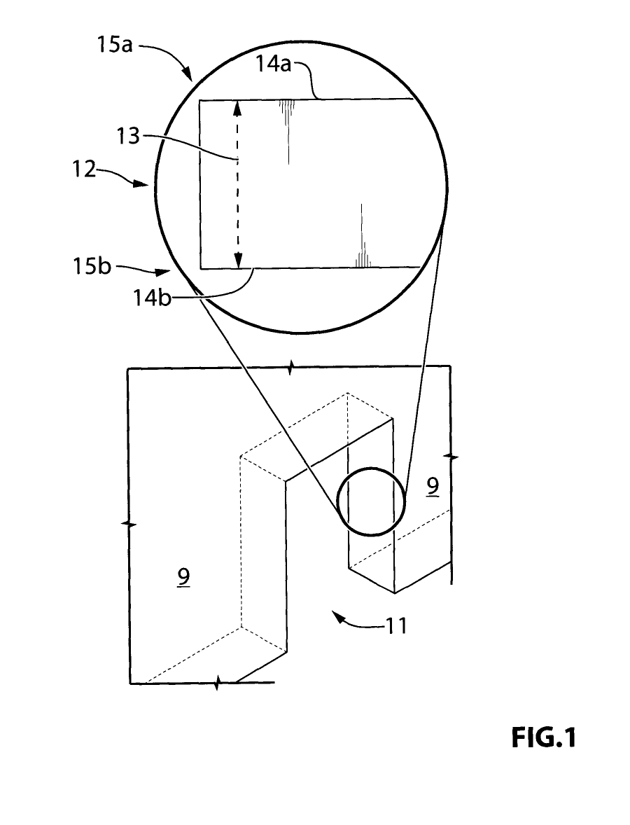

Referring now to the drawings, and more particularly to FIG. 1, there is shown a perspective view of a wall 9 defining a door opening 11. It is to be mentioned that the door opening 11 may also be understood to be a window opening, a garage opening and any other suitable opening for receiving a decorative foldable door frame 10 as described below. The opening 11 may be defined in the wall 9 by peripheral external surfaces 14a, 14b and an internal surface 12 which has a lateral length 13 (i.e., the thickness of the wall 9 or of the structure). FIG. 1 shows that edges 15a, 15b are defined at meeting points of the peripheral external surfaces 14a, 14b and the internal surface 12.

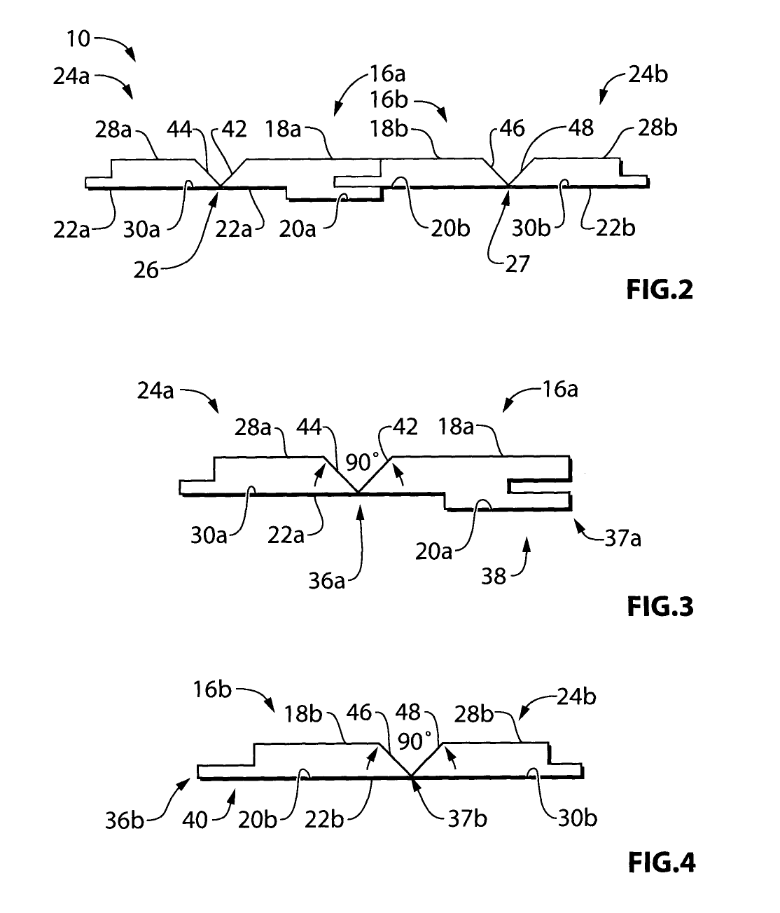

Referring now to FIGS. 2, 3 and 4, there is shown the decorative foldable door frame 10. The decorative foldable door frame 10 is to be interfacing with the peripheral external surfaces 14a, 14b and the internal surface 12 of the wall 9 defining the door opening 11. The decorative foldable door frame 10 includes internal mounting elements 16a, 16b. Each one of the internal mounting elements 16a, 16b defines an internal mounting surface 18a, 18b to be interfacing with the internal surface 12 and external surfaces 20a, 20b. The decorative foldable door frame 10 further includes external mounting elements 24a, 24b, where each one of the external mounting elements 24a, 24b is adjacent to longitudinal sides 26, 27 of the internal mounting elements 16a, 16b.

The external mounting elements 24a, 14b include or define internal mounting surfaces 28a, 28b which can fixedly interface with the peripheral external surfaces 14a, 14b respectively and external surfaces 30a, 30b.

Additionally, the decorative foldable door frame 10 includes foldable layers 22a, 22b. As shown in FIG. 2, the foldable layer 22a covers or layers the external surface 30a of the external mounting element 24a and the external surface 20a of the internal mounting element 16a, totally, or partially. On the other hand, the foldable layer 22b covers or layers the external surface 30b of the external mounting element 24b and the external surface 20b of the internal mounting element 16b, totally, or partially.

Still referring to FIG. 2, the foldable layers 22a, 22b totally covers the external surfaces 20a, 20b, 30a, 30b of the internal mounting elements 16a, 16b and the adjacent external mounting elements 24a, 24b.

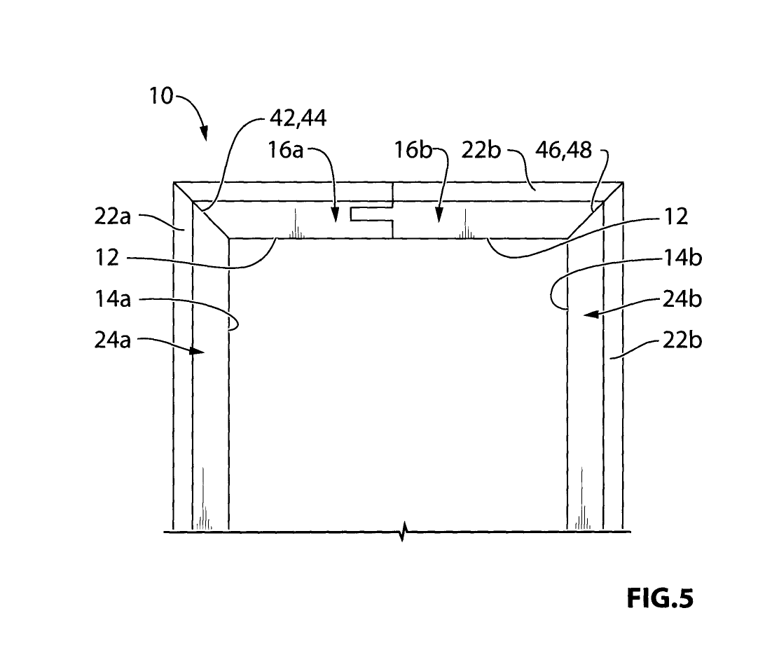

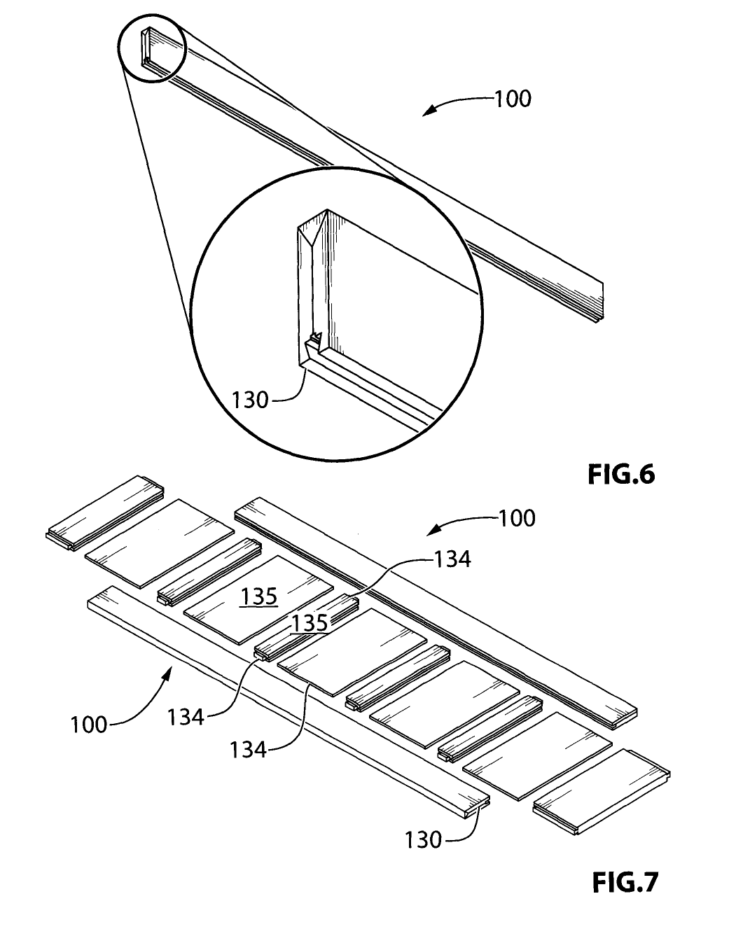

According to an embodiment, the foldable layers 22a, 22b may be integrally formed for allowing the decorative foldable door frame 10 to fold and unfold to adopt any positions between a non-installed position (FIGS. 2, 3 and 4) and an interfacing position (FIG. 5).

Now referring to FIGS. 3 and 4, there is shown the internal mounting elements 16a with the external mounting element 24a (FIG. 3) and the internal mounting elements 16b with the external mounting element 24b (FIG. 4). The internal mounting elements 16a, 16b each defines respective longitudinal opposed ends 36a, 37a, 36b, 37b. As shown, the end 37a of the internal mounting element 16a includes a mating connector 38 (FIG. 3) which can releasably connect with a corresponding mating connector 40 on the end 36b of the internal mounting element 16b (FIG. 4). However, it is to be noted that the internal mounting elements 16a, 16b may be integrally formed such that a decorative foldable door frame 10 may include only one internal mounting element and adjacent external mounting elements 24a, 24b without any mating connectors of the internal mounting element.

Furthermore, the internal mounting element 16a defines a longitudinal edge 42 as the internal mounting element 16b defines a longitudinal edge 46 (FIG. 2). Also, the external mounting elements 24a, 24b each define a corresponding edge 44, 48 (FIG. 2) for interfacing with the longitudinal edges 42, 46 of the internal mounting elements 16a, 16b when the decorative foldable door frame 10 adopts an interfacing position (FIG. 5).

Now referring to FIGS. 2, 3, 4 and 5, the longitudinal edge 42 of the internal mounting element 16a and the longitudinal edge 46 of the internal mounting element 16b define a 45° longitudinal edge. Moreover, the corresponding edge 44 of the external mounting element 24a and the corresponding edge 48 of the external mounting element 24b define a corresponding 45° longitudinal edge for interfacing with the longitudinal edges 42, 46 of the internal mounting elements 16a, 16b when adopting the interfacing position (FIG. 5).

Furthermore, the internal mounting elements 16a, 16b interact with the external mounting elements 24a, 24b for creating a 90° angle (FIGS. 3 and 4). As shown on FIG. 5, the 45° edges 42, 46 and the corresponding 45° edges 44, 48 interact and interface to position the decorative foldable door frame 10 in its interfacing position.

Also, the internal mounting elements 16a, 16b and/or the external mounting elements 24a, 24b may be fixed to the internal surface 12 or the peripheral external surfaces 14a, 14b (FIGS. 1 and 5) of wall 9 defining the door opening 11 using, without limitation, screws, nails, glue, dove tail elements and any other suitable fastener for fixing the internal mounting elements 16a, 16b and/or the external mounting elements 24a, 24b to the internal surface 12 or to the peripheral external surfaces 14a, 14b. More preferably, the internal mounting elements 16a, 16b are interfacing with the internal surface 12 and the external mounting elements 24a, 24b are fixed to the peripheral external surfaces 14a, 14b.

According to an embodiment, the internal mounting elements 16a, 16b and the external mounting elements 24a, 24b may include, without limitation, a medium-density fiberboard material (i.e., MDF), a low-density fiberboard material (i.e., LDF), a high-density fiberboard material (i.e., HDF), a particle board, a wood material, a metallic material, a polymeric material, any combinations, and any other suitable material for use of the decorative foldable door frame 10 in indoor conditions or in outdoor conditions (or in both indoor and outdoor conditions).

According to another embodiment, the foldable layers 22a, 22b may include, without limitation, a thermoplastic material, a plastic material, a polymeric material, a metallic material, a linerboard material, any combinations, and any suitable material for allowing the decorative foldable door frame 10 to be folded and unfolded between a non-installed position (FIGS. 2, 3, 4) and an interfacing position (FIG. 5). Thus, the foldable layers 22a, 22b need to be flexible and strength such as to fold and unfolded without damage or with reduced risks of damages.

As shown in FIGS. 2-5, the foldable layers 22a, 22b may cover the internal mounting surfaces 18a, 28a, 18b, 28b of the internal mounting elements 16a, 16b and of the external mounting elements 24a, 24b. However, it is to be noted that the foldable layers 22a, 22b may partially or totally covers the internal mounting surfaces 18a, 28a, 18b, 28b of the internal mounting elements 16a, 16b and of the external mounting elements 24a, 24b.

According to another embodiment, the foldable layers 22a, 22b may also cover the external surfaces 20a, 30a, 20b, 30b of the internal mounting elements 16a, 16b and of the external mounting elements 24a, 24b. It is to be noted that in both cases, the foldable layers 22a, 22b may be weakened at longitudinal lines (not shown) corresponding to the longitudinal sides 26, 27 respectively between the internal mounting element 16a and the external mounting element 24a and the internal mounting element 16b and the external mounting element 24b. In this case, the decorative foldable door frame 10 may fold and unfold to adopt any position between the non installed position (FIGS. 2-4 and 3) and the interfacing position (FIG. 5).

According to another embodiment, the foldable layers 22a, 22b may partially or totally cover the external surfaces 20a, 30a, 20b, 30b of the internal mounting elements 16a, 16b and of the external mounting elements 24a, 24b.

In the scenario where the foldable layers 22a, 22b cover the internal mounting surfaces 18a, 28a, 18b, 28b of the internal mounting elements 16a, 16b and the external mounting elements 24a, 24b, the foldable layers 22a, 22b may further include at least one foldable fin (i.e., or projecting portion, not shown) outwardly extending from the foldable layers 22a, 22b.

It is to be notated that, the internal mounting element 16a adjacent with the external mounting element 24a via the foldable layer 22a and the internal mounting element 16b adjacent with the external mounting element 24b via the foldable layer 22b may come into a kit for allowing a user to releasably connect them, via the mating connectors 38 and 40 of the internal mounting elements 16a, 16b.

It is to be noted that the ends of the external mounting elements 24a, 24b opposite the ends 37a, 36b with the mating connectors each include a mating connector for releasably connecting with a corresponding mating connector (not shown) of a decorative element (i.e., a decorative molding).

According to another embodiment and referring now to FIGS. 6-9, there is shown a decorative foldable door member 100. The decorative foldable door member 100 includes an internal mounting element 112 defining internal interfacing surfaces 114a, 114b and an external surface 116. The decorative foldable door member 100 also includes external mounting elements 118a, 118b adjacent to each longitudinal ends 120, 122 of the internal mounting element 112. The external mounting elements 118a, 118b define external surfaces 124a, 124b and internal interfacing surfaces 126a, 126b. One internal interfacing surface 126a of the external mounting elements 118a is for interfacing with the internal interfacing surface 126b of the external mounting element 118b when the decorative foldable door member 100 is in an interfacing position (FIGS. 6, 7 and 9). The decorative foldable door member 100 further includes a foldable layer 128 which covers the external surfaces 124a, 124b and 116 of the external mounting elements 118a, 118b and of the internal mounting element 112. It is however to be noted that a foldable layer 128 may also covers the internal interfacing surfaces 114a, 114b, 126a and/or 126b of the internal mounting element 112 and of the external mounting elements 118a, 118b.

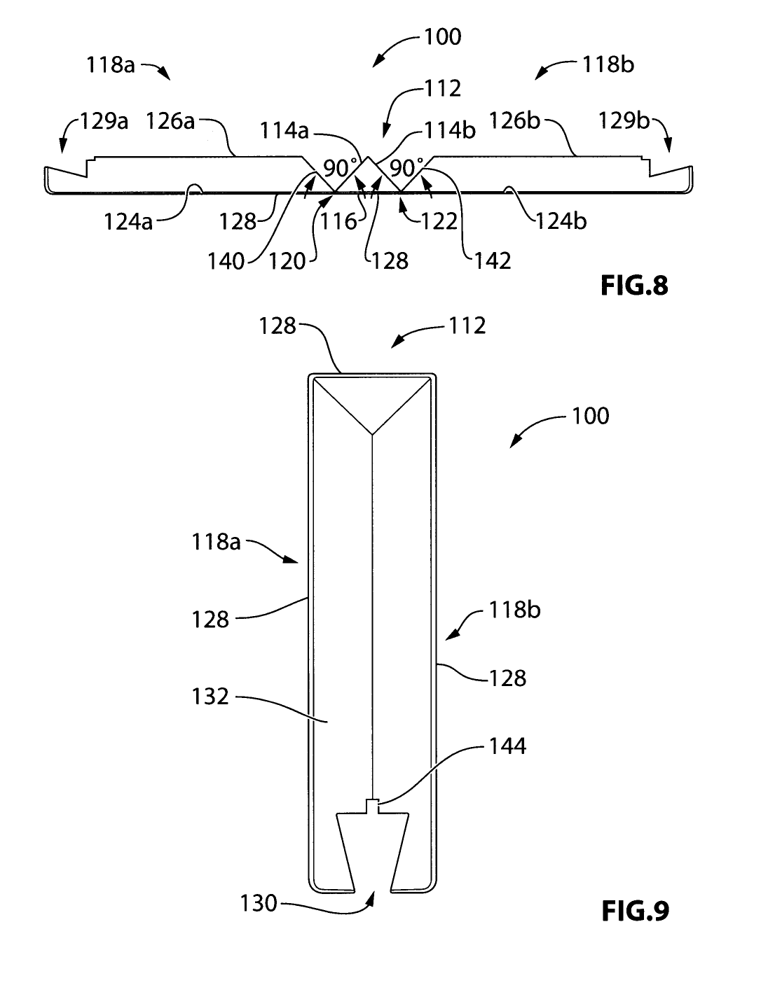

According to FIGS. 6-9, the foldable layer 128 covers the external surface 116 of the internal mounting element 112 and the external surface 124a, 124b of the external mounting elements 118a, 118b. The foldable layer 128 is integrally formed for allowing the decorative foldable door member 100 to fold and unfold to adopt any position between a non-interfacing position (FIG. 8) and an interfacing position (FIGS. 6, 7 and 9).

When adopting the interfacing position (FIGS. 6, 7 and 9), the internal interfacing surfaces 126a, 126b of the external mounting elements 118a, 118 are interfacing for creating a mating connector 130 at a distal end 132 (FIG. 9) of the decorative foldable door member 100 to receive at least one corresponding mating connector 134. In other words, each one of the external mounting elements 118a, 118b defines a recess 129a, 129b at an end opposed to the internal mounting surface 112 to be aligned with the other one of the recess 129a, 129b when in the interfacing position and thereby providing the decorative foldable door member 100 with a mating connector 130 which has a suitable shape and configuration to releasably match with a corresponding mating connector 134 of another door member 135.

The external mounting elements 118a, 118b define a corresponding edge 140 for interfacing with the internal interfacing surface 114a of the internal mounting element 112 and a corresponding edge 142 for interfacing with the internal interfacing surface 114b of the internal mounting element 112 when the decorative foldable door member adopts the interfacing position (FIGS. 6, 7 and 9).

The internal interfacing surface 114a and the internal interfacing surface 114b define in FIGS. 6-9 a 45° longitudinal edge. The internal interfacing surfaces 114a, 114b of the internal mounting element 112 include a 45° longitudinal edge for interfacing with the corresponding edges 140, 142 of the external mounting elements 118a, 118b respectively. However, it is to be noted that any suitable angle, shape and configuration may be used such as to allow the edges 140, 142 of the external mounting elements 118a, 118b to interface with the internal interfacing surfaces 114a, 114b of the internal mounting element 112 when the decorative foldable door member adopts its interfacing position.

The internal mounting element 112 interacts with the two external mounting elements 118a, 118b for creating a 90° angle.

According to an embodiment, the internal mounting element 112 and the external mounting elements 118a, 118b may include, without limitation, a medium-density fiberboard material, a wood material, a metallic material, a polymeric material, any combination, and any other suitable material.

According to another embodiment, the foldable layer 128 may include, without limitation, a thermoplastic material, a plastic material, a polymeric material, a metallic material, a linerboard material, any combination, and any other suitable material for allowing the decorative foldable door member 100 to be folded and unfolded between a non-installed position (FIG. 8) and an interfacing position (FIGS. 6, 7 and 9). Thus, the foldable layer 128 needs to be flexible and strength such as to fold and unfolded without damage or with reduced risks of damages.

According to another embodiment, the foldable layer 128 may cover the internal interfacing surfaces 114a, 114b of the internal mounting element 112 and the external mounting elements 118a, 118b. The foldable layer 128 may partially cover the internal interfacing surfaces 114a, 114b of the internal mounting element 112 and of the external mounting elements 118a, 118b.

According to another embodiment, the foldable layer 128 may cover the external surfaces 116, 124a, 124b of the internal/external mounting elements 112, 118a and 118b. The foldable layer 128 may partially cover the external surfaces 116, 124a and 124b of the internal/external mounting elements 112, 118a, 118b.

According to another embodiment, the foldable layer 128 may further include at least one foldable fin (i.e., outwardly projecting portion) outwardly extending from the foldable layer 128. Indeed, during the installation of the decorative foldable door member 100, it will be easier with the fins or projecting portions (not shown) to control the position of the decorative foldable door member 100 between the non interlacing position and the interlacing position.

According to another embodiment, the mating connector 130 formed within the external mounting elements 118a, 118b (i.e., at their respective ends) when in the interfacing position, may further define a compartment 144 for receiving a liquid composition (i.e. glue or adhesive composition) for facilitating the installation of the decorative foldable door member 100 and the connection with the corresponding mating connectors 134 of the other door members 135.

It is to be noted that in embodiments, the foldable layer 128 may be weakened at places corresponding to the longitudinal ends 120, 122 of the internal mounting element 112. In this scenario, the decorative foldable door member 100 may fold and unfold to adopt any position between the non-interfacing position and the interfacing position.

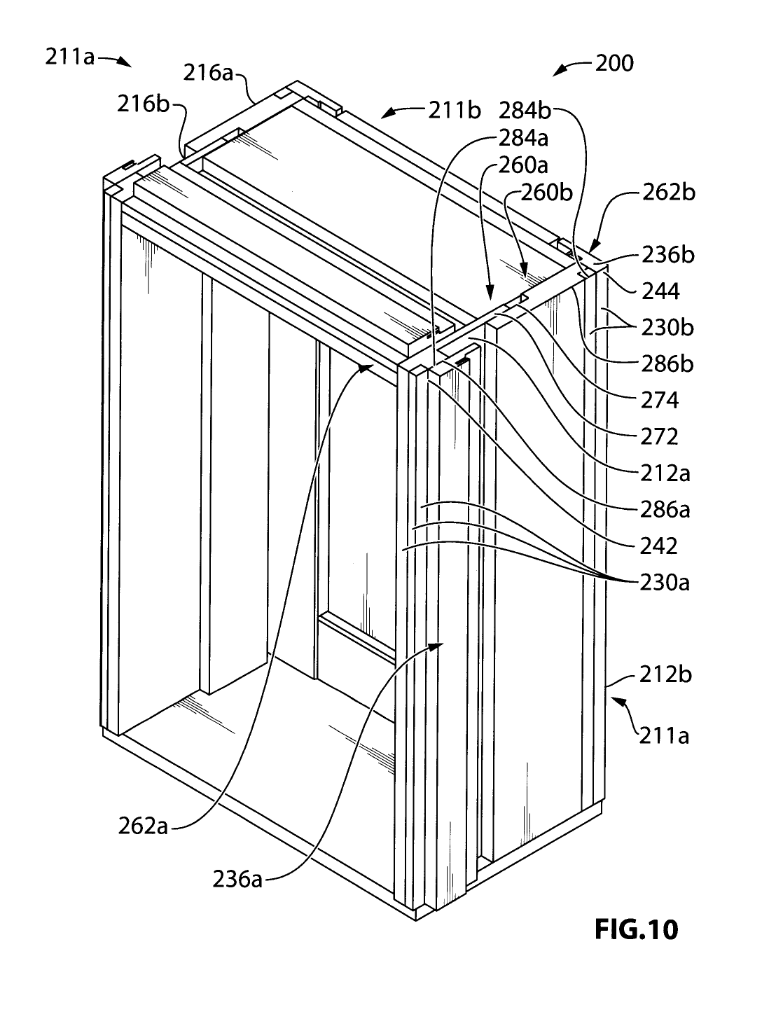

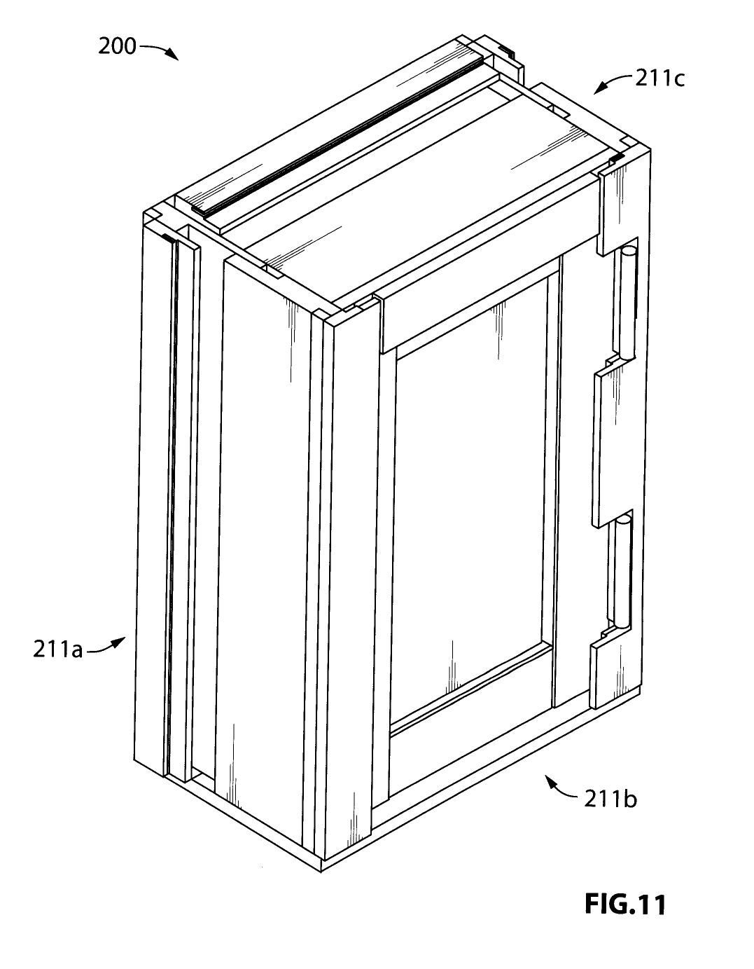

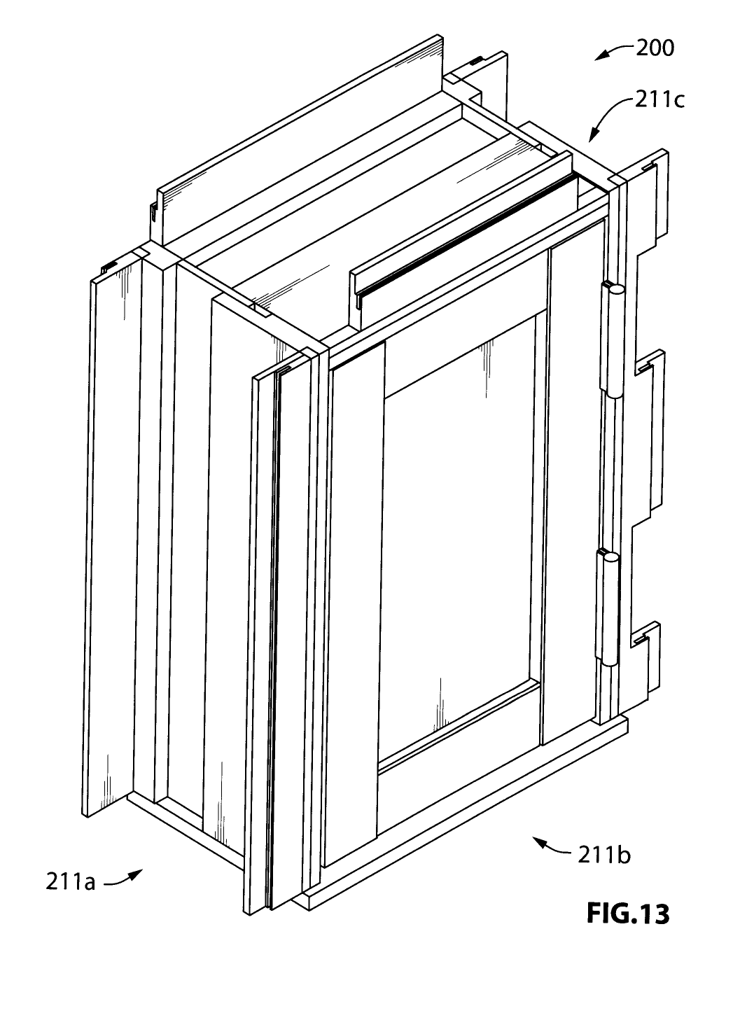

According to another embodiment and referring now to FIGS. 10-13 and 14A-14D, there is shown a foldable door frame assembly 200 to be interfacing with an opening defined by a wall.

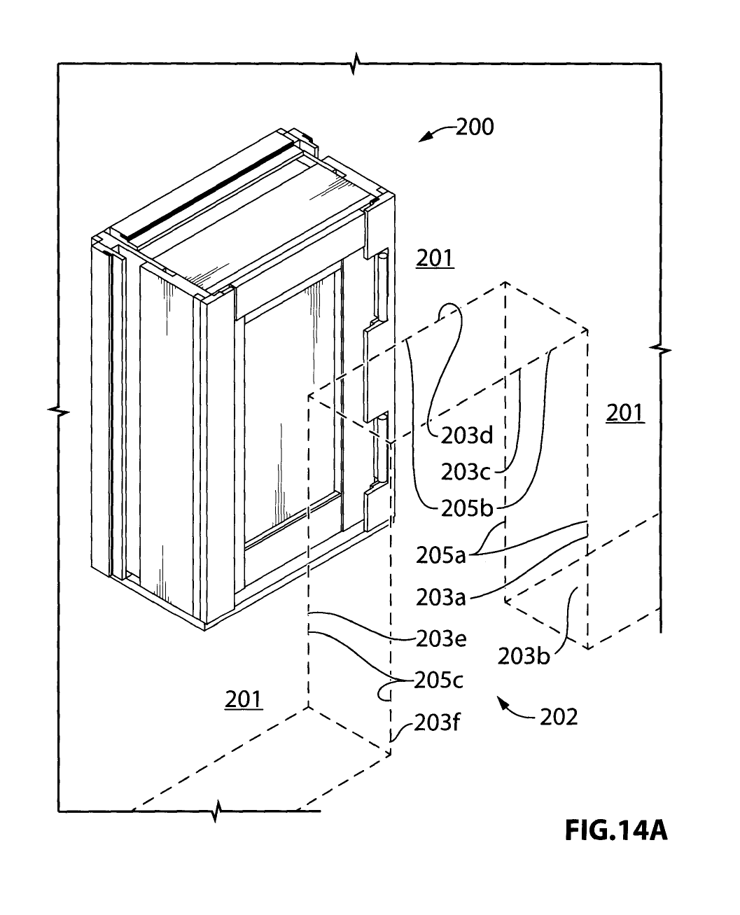

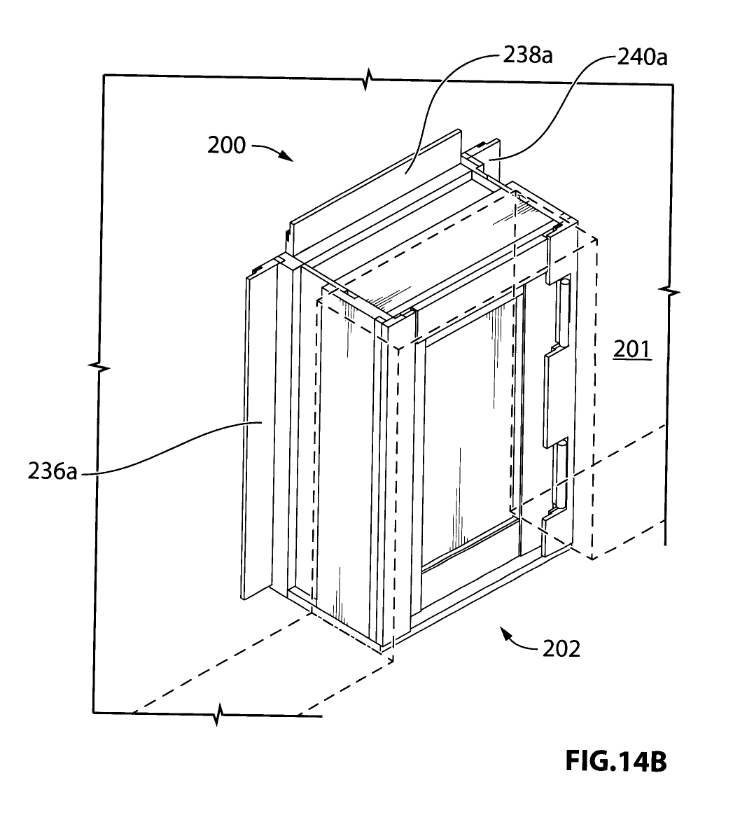

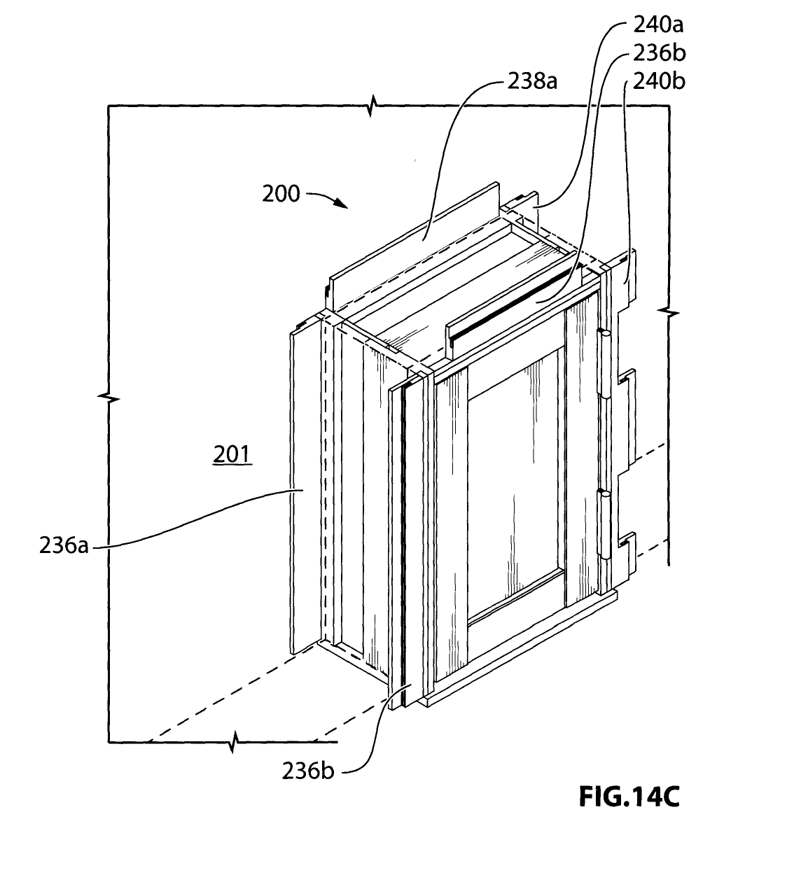

In FIGS. 14A-14D, there is shown a perspective view of a wall 201 defining a door opening 202. It is to be mentioned that the door opening 202 may also be understood to be a window opening, a garage opening and any other suitable opening for receiving a foldable door frame assembly 200 as described below. The opening 202 may be defined in the wall 201 by peripheral external surfaces 203a-203f and internal surfaces 205a-205c which have lateral lengths (i.e., the thickness of the wall 201 or of the structure). FIGS. 14A-14D show that edges are defined at meeting points of the peripheral external surfaces 203a-203f and the internal surfaces 205a-205c.

Referring now to FIGS. 10-13, there is shown the foldable door frame assembly 200. The foldable door frame assembly 200 is to be interfacing with the peripheral external surfaces 203a-203f and the internal surfaces 205a-205c of the wall 201 defining the door opening 202. The foldable door frame assembly 10 includes at least three decorative foldable door frames 211a, 211 b, 211c. Each one of the decorative foldable door frames 211a, 211b, 211c extends from another one of the decorative foldable door frames 211a, 211 b, 211c. The decorative foldable door assembly 211a includes internal mounting elements 212a, 212b. Each one of the internal mounting elements 212a, 212b defines internal mounting surface 218a, 218b to be interfacing with the internal surface 205a and external surfaces 203a, 203b. The decorative foldable door frame 211a further includes external mounting elements 236a, 236b, where each one of the external mounting elements 236a, 236b is adjacent to longitudinal sides 242, 244 of the internal mounting elements 212a, 212b.

The external mounting elements 236a, 236b include or define internal mounting surfaces 254a, 254b which can interface with the peripheral external surfaces 203a, 203b respectively and external surfaces 259a, 259b.

Additionally, the decorative foldable door frame 211a includes foldable layers 230a, 230b. The foldable layers 230a covers or layers the external surface 259a of the external mounting element 236a and the external surface 224a of the internal mounting element 212a, totally, or partially. On the other hand, the foldable layer 230b covers or layers the external surface 259b of the external mounting element 236b and the external surface 224b of the internal mounting element 212b, totally, or partially.

The foldable layers 230a, 230b totally covers the external surfaces 224a, 224b, 259a, 259b of the internal mounting elements 212a, 212b and the adjacent external mounting elements 236a, 236b.

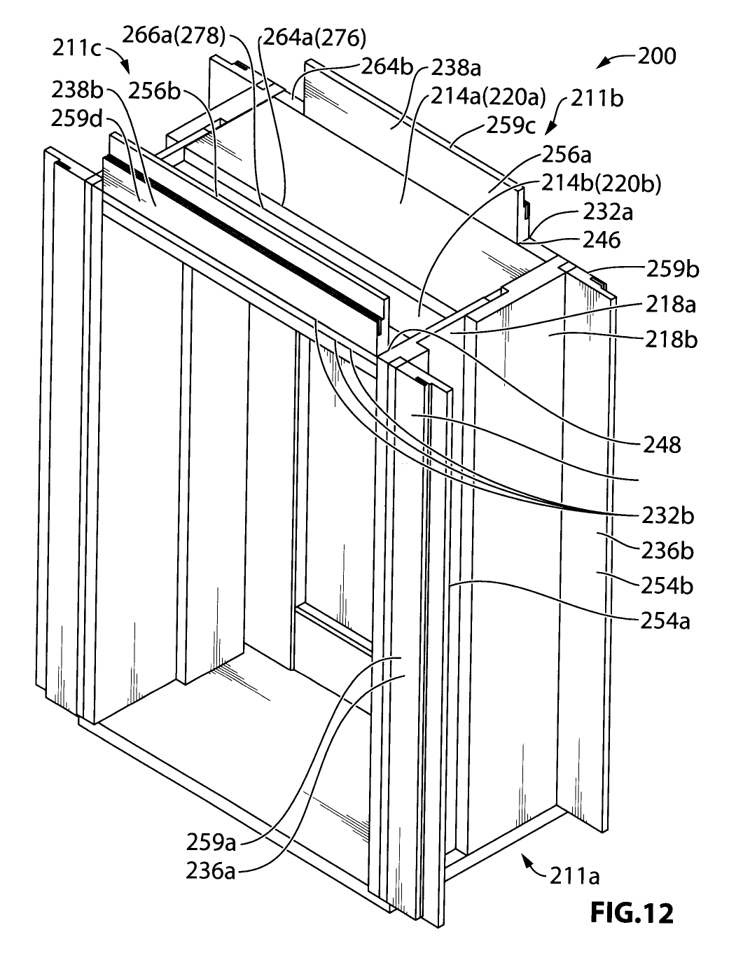

According to an embodiment, the foldable layers 230a, 230b may be integrally formed for allowing the decorative foldable door frame 211a to fold and unfold to adopt any positions between a non installed position (FIGS. 10, 11, 14A and 14B) and an interfacing position (FIGS. 12, 13, 14C and 14D).

The internal mounting elements 212a, 212b each defines respective longitudinal opposed ends 260a, 260b, 262a, 262b. As shown, the end 260a of the internal mounting element 212a includes a mating connector 272 which can releasably connect with a corresponding mating connector 274 on the end 260b of the internal mounting element 212b. However, it is to be noted that the internal mounting elements 212a, 212b may be integrally formed such that a decorative foldable door frame 211a may include only one internal mounting element and adjacent external mounting elements 236a, 236b without any mating connectors on the internal mounting element.

Furthermore, the internal mounting element 212a defines a longitudinal edge 284a as the internal mounting element 212b defines a longitudinal edge 284b. Also, the external mounting elements 236a, 236b each define a corresponding edge 286a, 286b for interfacing with the longitudinal edges 284a, 284b of the internal mounting elements 212a, 212b when the decorative foldable door frame 211a adopts an interfacing position (FIGS. 12, 13, 14C and 14D).

The longitudinal edge 284a of the internal mounting element 212a and the longitudinal edge 284b of the internal mounting element 212b define a 90° longitudinal edge. Moreover, the corresponding edge 286a of the external mounting element 236a and the corresponding edge 286b of the external mounting element 236b define a corresponding 90° longitudinal edge for interfacing with the longitudinal edges 284a, 284b of the internal mounting elements 212a, 212b when adopting the interfacing position (FIGS. 12, 13, 14C and 14D).

Similarly, the decorative foldable door frame 211b includes internal mounting elements 214a, 214b. Each one of the internal mounting elements 214a, 214b defines internal mounting surface 220a, 220b to be interfacing with the internal surface 205b and external surfaces 203c, 203d. The decorative foldable door frame 211b further includes external mounting elements 238a, 238b, where each one of the external mounting elements 238a, 238b is adjacent to longitudinal sides 246, 248 of the internal mounting elements 214a, 214b.

The external mounting elements 238a, 238b include or define internal mounting surfaces 256a, 256b which can interface with the peripheral external surfaces 203c, 203d respectively and external surfaces 259c, 259d.

Additionally, the decorative foldable door frame 211b includes foldable layers 232a, 232b. The foldable layer 232a covers or layers the external surface 259c of the external mounting element 238a and the external surface 226a of the internal mounting element 214a, totally, or partially. On the other hand, the foldable layer 232b covers or layers the external surface 259d of the external mounting element 238b and the external surface 226b of the internal mounting element 214b, totally, or partially.

The foldable layers 232a, 232b totally covers the external surfaces 226a, 226b, 259c, 259d of the internal mounting elements 214a, 214b and the adjacent external mounting elements 238a, 238b.

According to an embodiment, the foldable layers 232a, 232b may be integrally formed for allowing the decorative foldable door frame 211b to fold and unfold to adopt any positions between a non installed position (FIGS. 10, 11, 14A and 14B) and an interfacing position (FIGS. 12, 13, 14C and 14D).

The internal mounting elements 214a, 214b each defines respective longitudinal opposed ends 264a, 264b, 266a, 266b. As shown, the end 264a of the internal mounting element 214a includes a mating connector 276 which can releasably connect with a corresponding mating connector 278 on the end 266a of the internal mounting element 214b. However, it is to be noted that the internal mounting elements 214a, 214b may be integrally formed such that a decorative foldable door frame 211b may include only one internal mounting element and adjacent external mounting elements 238a, 238b without any mating connectors on the internal mounting element.

Furthermore, the internal mounting element 214a defines a longitudinal edge 288a as the internal mounting element 214b defines a longitudinal edge 288b. Also, the external mounting elements 238a, 238b each define a corresponding edge 290a, 290b for interfacing with the longitudinal edges 288a, 288b of the internal mounting elements 214a, 214b when the decorative foldable door frame 211b adopts an interfacing position (FIGS. 12, 13, 14C and 14D).

The longitudinal edge 288a of the internal mounting element 214a and the longitudinal edge 288b of the internal mounting element 214b define a 90° longitudinal edge. Moreover, the corresponding edge 290a of the external mounting element 238a and the corresponding edge 290b of the external mounting element 238b define a corresponding 90° longitudinal edge for interfacing with the longitudinal edges 288a, 288b of the internal mounting elements 214a, 214b when adopting the interfacing position (FIGS. 12, 13, 14C and 14D).

Similarly, the decorative foldable door frame 211c includes internal mounting elements 216a, 216b (It is to be noted that some reference numeral are not shown for the decorative foldable door frame 211c, but can be referred to the foldable door frames 211a and 211b). Each one of the internal mounting elements 216a, 216b defines internal mounting surface 222a, 222b to be interfacing with the internal surface 205c and external surfaces 203e, 203f. The decorative foldable door frame 211c further includes external mounting elements 240a, 240b, where each one of the external mounting elements 240a, 240b is adjacent to longitudinal sides 250, 252 of the internal mounting elements 216a, 216b.

The external mounting elements 240a, 240b include or define internal mounting surfaces 258a, 258b which can interface with the peripheral external surfaces 203e, 203f respectively and external surfaces 259e, 259f.

Additionally, the decorative foldable door frame 211c includes foldable layers 234a, 234b. The foldable layer 234a covers or layers the external surface 259e of the external mounting element 240a and the external surface 228a of the internal mounting element 216a, totally, or partially. On the other hand, the foldable layer 234b covers or layers the external surface 259f of the external mounting element 240b and the external surface 228b of the internal mounting element 218b, totally, or partially.

The foldable layers 234a, 234b totally covers the external surfaces 228a, 228b, 259e, 259f of the internal mounting elements 216a, 216b and the adjacent external mounting elements 240a, 240b.

According to an embodiment, the foldable layers 234a, 234b may be integrally formed for allowing the decorative foldable door frame 211c to fold and unfold to adopt any positions between a non installed position (FIGS. 10, 11, 14A and 14B) and an interfacing position (FIGS. 12, 13, 14C and 14D).

The internal mounting elements 216a, 216b each defines respective longitudinal opposed ends 268a, 268b, 270a, 270b. As shown, the end 268a of the internal mounting element 216a includes a mating connector 280 which can releasably connect with a corresponding mating connector 284 on the end 270a of the internal mounting element 216b. However, it is to be noted that the internal mounting elements 216a, 216b may be integrally formed such that a decorative foldable door frame 211c may include only one internal mounting element and adjacent external mounting elements 240a, 240b without any mating connectors on the internal mounting element.

Furthermore, the internal mounting element 216a defines a longitudinal edge 292a as the internal mounting element 216b defines a longitudinal edge 292b. Also, the external mounting elements 240a, 240b each define a corresponding edge 294a, 294b for interfacing with the longitudinal edges 292a, 292b of the internal mounting elements 216a, 216b when the decorative foldable door frame 211c adopts an interfacing position (FIGS. 12, 13, 14C and 14D).

The longitudinal edge 292a of the internal mounting element 216a and the longitudinal edge 292b of the internal mounting element 216b define a 90° longitudinal edge. Moreover, the corresponding edge 294a of the external mounting element 240a and the corresponding edge 294b of the external mounting element 240b define a corresponding 90° longitudinal edge for interfacing with the longitudinal edges 292a, 292b of the internal mounting elements 216a, 216b when adopting the interfacing position (FIGS. 12, 13, 14C and 14D).

Also, the internal mounting elements 212a, 212b, 214a, 214b, 216a, 216b and/or the external mounting elements 236a, 236b, 238a, 238b, 240a, 240b may be fixed to the internal surfaces 205a, 205b and/or 205c or the peripheral external surfaces 203a-f of wall 201 defining the door opening 202 using, without limitation, screws, nails, glue, dove tail elements and any other suitable fastener for fixing the internal mounting elements 212a, 212b, 214a, 214b, 216a, 216b and/or the external mounting elements 236a, 236b, 238a, 238b, 240a, 240b to the internal surfaces 205a, 205b and/or 205c or to the peripheral external surfaces 203a-f. More preferably, the internal mounting elements 212a, 212b, 214a, 214b, 216a, 216b are interfacing with the internal surface 205a, 205b and/or 205c and the external mounting elements 236a, 236b, 238a, 238b, 240a, 240b are fixed to the peripheral external surfaces 203a-f.

According to an embodiment, the internal mounting elements 212a, 212b, 214a, 214b, 216a, 216b and the external mounting elements 236a, 236b, 238a, 238b, 240a, 240b may include, without limitation, a medium-density fiberboard material (i.e., MDF), a low-density fiberboard material (i.e., LDF), a high-density fiberboard material (i.e., HDF), a particle board, a wood material, a metallic material, a polymeric material, any combinations, and any other suitable material for use of the decorative foldable door frames 211a, 211b, 211c in indoor conditions or in outdoor conditions (or in both indoor and outdoor conditions).

According to another embodiment, the foldable layers 230a, 230b, 232a, 232b, 234a, 234b may include, without limitation, a thermoplastic material, a plastic material, a polymeric material, a metallic material, a linerboard material, any combinations, and any suitable material for allowing the decorative foldable door assembly 200 to be folded and unfolded between a non-installed position and an interfacing position. Thus, the foldable layers 230a, 230b, 232a, 232b, 234a, 234b need to be flexible and strength such as to fold and unfolded without damage.

The foldable layers 230a, 230b, 232a, 232b, 234a, 234b may cover the internal mounting surfaces 218a, 218b, 220a, 220b, 222a, 222b of the internal mounting elements 212a, 212b, 214a, 214b, 216a, 216b and of the external mounting elements 236a, 236b, 238a, 238b, 240a, 240b. However, it is to be noted that the foldable layers 230a, 230b, 232a, 232b, 234a, 234b may partially or totally covers the internal mounting surfaces 218a, 218b, 220a, 220b, 222a, 222b of the internal mounting elements 212a, 212b, 214a, 214b, 216a, 216b and of the external mounting elements 236a, 236b, 238a, 238b, 240a, 240b.

According to another embodiment, the foldable layers 230a, 230b, 232a, 232b, 234a, 234b may also cover the external surfaces 224a, 224b, 226a, 226b, 228a, 228b, 259a-f of the internal mounting elements 212a, 212b, 214a, 214b, 216a, 216b and of the external mounting elements 236a, 236b, 238a, 238b, 240a, 240b. It is to be noted that in both cases, the foldable layers 230a, 230b, 232a, 232b, 234a, 234b may be weakened at longitudinal lines (not shown) corresponding to the longitudinal sides respectively between the internal mounting elements 212a, 212b, 214a, 214b, 216a, 216b and the external mounting elements 236a, 236b, 238a, 238b, 240a, 240b. In this case, the decorative foldable door frames 211a-c may fold and unfold to adopt any position between the non-installed position and the interlacing position.

In use and referring now to FIGS. 14A-14D, the foldable door assembly 200 is in its folded position in FIG. 14A. In FIG. 14B, external mounting elements 236a, 238a and 240a adopt unfolded positions and a portion of the foldable door frame assembly 200 is introduced within the opening 202 defined by the wall 201. In FIG. 14C, the external mounting elements 236b, 238b and 240c also adopt the unfolded positions. Then, the external mounting elements 236a, 236b, 238a, 238b, 240a and 240b can now interface with the peripheral external surfaces 203a-203f of the wall 201. FIG. 14D shows that the foldable door frame assembly 200 is operative since a door can then be opened and closed.

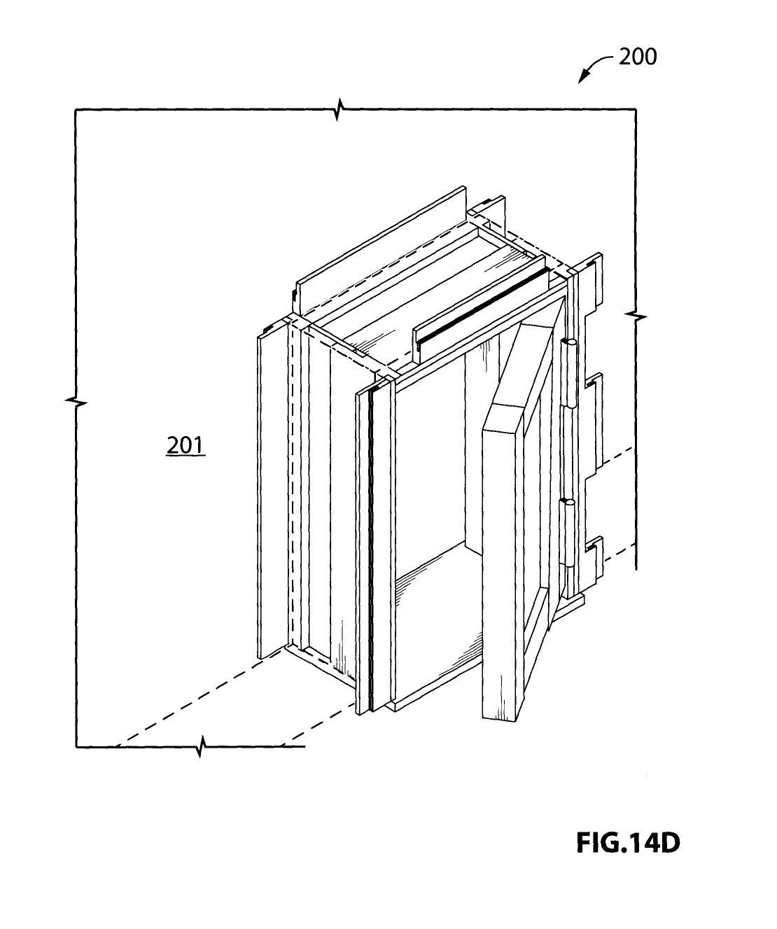

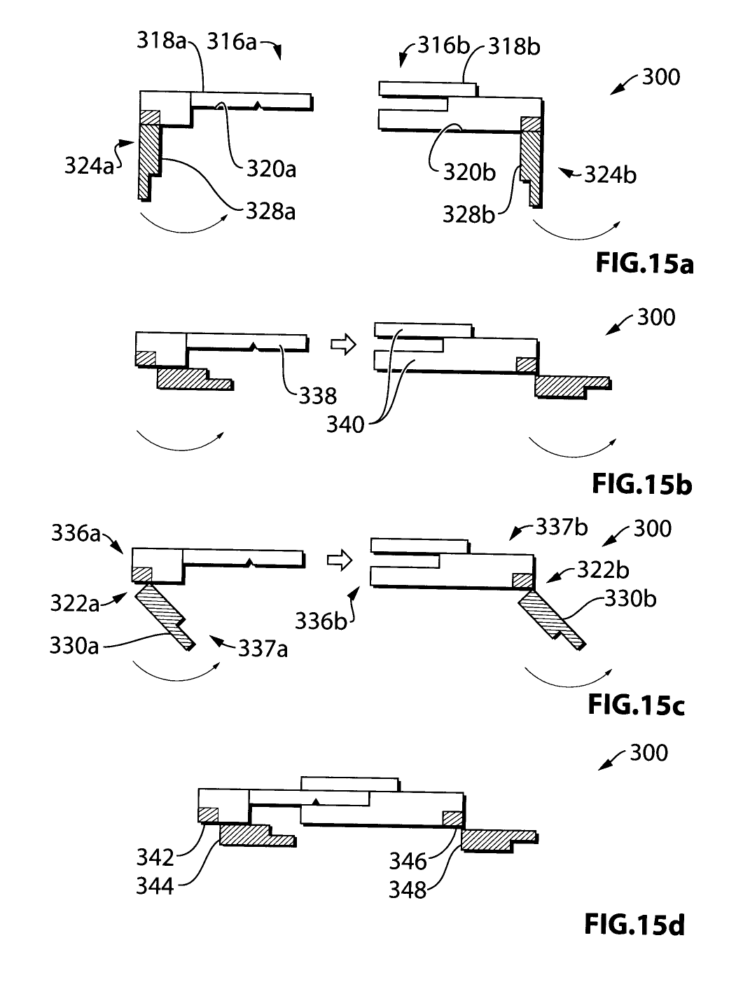

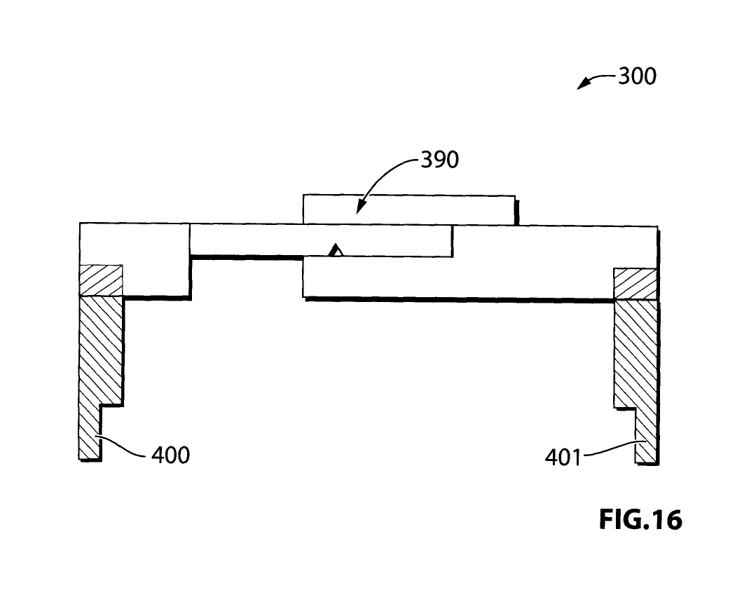

According to another embodiment and referring now to FIGS. 15A-15D and 16, there is shown another embodiment of a decorative foldable frame 300. FIG. 15A is a side elevation view of a decorative foldable door frame 300 in a non-installed position. FIG. 15B is another side elevation view of the decorative foldable door frame 300 of FIG. 15A in a non-installed position. FIG. 15C is another side elevation view of the decorative foldable door frame 300 of FIG. 15A in a non-installed position. FIG. 15D is another side elevation view of the decorative foldable door frame 300 of FIG. 15A in a non-installed position, where the mating connectors are releasably connected and FIG. 16 is a side elevation view of the decorative foldable door frame 300 of FIGS. 15A-15D in an installed position in accordance with another embodiment.

The decorative foldable door frame 300 is to be interfacing with the peripheral external surfaces 14a, 14b and the internal surface 12 of the wall 9 defining the door opening 11 (FIG. 1). The decorative foldable door frame 300 includes internal mounting elements 316a, 316b. Each one of the internal mounting elements 316a, 316b defines an internal mounting surface 318a, 318b to be interlacing with the internal surface 12 and external surfaces 320a, 320b. The decorative foldable door frame 300 further includes external mounting elements 324a, 324b, where each one of the external mounting elements 324a, 324b is adjacent to longitudinal sides 326, 327 of the internal mounting elements 316a, 316b.

The external mounting elements 324a, 324b include or define internal mounting surfaces 328a, 328b which can fixedly interface with the peripheral external surfaces 14a, 14b respectively and external surfaces 330a, 330b.

Additionally, the decorative foldable door frame 300 includes foldable layers 322a, 322b. As shown in FIGS. 15A-16, the foldable layer 322a covers or layers the external surface 330a of the external mounting element 324a and the external surface 320a of the internal mounting element 316a, totally, or partially. On the other hand, the foldable layer 322b covers or layers the external surface 330b of the external mounting element 324b and the external surface 320b of the internal mounting element 316b, totally, or partially.

Still referring to FIGS. 15A-16, the foldable layers 322a, 322b totally covers the external surfaces 320a, 320b, 330a, 330b of the internal mounting elements 316a, 316b and the adjacent external mounting elements 324a, 324b.

According to an embodiment, the foldable layers 322a, 322b may be integrally formed for allowing the decorative foldable door frame 300 to fold and unfold to adopt any positions between a non-installed position (FIGS. 15A, 15B, 15C and 15D) and an interfacing position (FIG. 16).

Still referring to FIGS. 15A-16, there is shown the internal mounting elements 316a with the external mounting element 324a and the internal mounting elements 316b with the external mounting element 324b. The internal mounting elements 316a, 316b each defines respective longitudinal opposed ends 336a, 337a, 336b, 337b. As shown, the end 337a of the internal mounting element 316a includes a mating connector 338 which can releasably connect with a corresponding mating connector 340 on the end 336b of the internal mounting element 316b (FIG. 16). However, it is to be noted that the internal mounting elements 316a, 316b may be integrally formed such that a decorative foldable door frame 300 may include only one internal mounting element and adjacent external mounting elements 324a, 324b without any mating connectors of the internal mounting element.

Furthermore, the internal mounting element 316a defines a longitudinal edge 342 as the internal mounting element 316b defines a longitudinal edge 346 (FIGS. 15B, 15C and 15D). Also, the external mounting elements 324a, 324b each define a corresponding edge 344, 348 (FIGS. 15B, 15C and 15D) for interfacing with the longitudinal edges 342, 346 of the internal mounting elements 316a, 316b when the decorative foldable door frame 300 adopts an interfacing position (FIGS. 15A and 16). The longitudinal edge 342 of the internal mounting element 316a and the longitudinal edge 346 of the internal mounting element 316b define a flat longitudinal edge. Moreover, the corresponding edge 344 of the external mounting element 324a and the corresponding edge 348 of the external mounting element 324b define a corresponding flat longitudinal edge for interfacing with the flat longitudinal edges 342, 346 of the internal mounting elements 316a, 316b when adopting the interfacing position (FIGS. 15A and 16). It is to be noted that the external mounting elements 324a, 324b may fold and unfolded between 0° and 90° from the internal mounting elements 316a, 316b respectively. A shown in FIG. 15A, the flat longitudinal edges 342, 346 interface the flat corresponding edges 344, 348 of the external mounting elements 324a, 324b for allowing the external mounting elements 324a, 324b to be in the interfacing position for interfacing with the peripheral external surfaces 14a, 14b (FIG. 1). However, in FIG. 15B, there is shown that the flat longitudinal edges 342, 346 do not interface the flat corresponding edges 344, 348 of the external mounting elements 324a, 324b for allowing the external mounting elements 324a, 324b to be in the non-installed position. Then, there is shown in FIG. 15C that the flat longitudinal edges 342, 346 do not interface the flat corresponding edges 344, 348 of the external mounting elements 324a, 324b for allowing the external mounting elements 324a, 324b to be in the interfacing position for interfacing with the peripheral external surfaces 14a, 14b (FIG. 1). In FIG. 15C, the external mounting elements 324a, 324b are at angle of about 45° from the respective internal mounting elements 316a, 316b. In FIG. 15D, there is shown that the flat longitudinal edges 342, 346 do not interface the flat corresponding edges 344, 348 of the external mounting elements 324a, 324b for allowing the external mounting elements 324a, 324b to be in the non-installed position. However, in FIG. 15D, the mating connector 338 is releasably connected with the corresponding mating connector 340.

Furthermore, the internal mounting elements 316a, 316b interact with the external mounting elements 324a, 324b for creating a 90° angle (FIG. 16). As shown on FIG. 16, the flat edges 342, 346 and the flat edges 344, 348 interact and interface to position the decorative foldable door frame 300 in its interfacing position (i.e., the internal mounting elements 316a, 316b and the external mounting elements 324a, 324b are at a 90° angle).

Also, the internal mounting elements 316a, 316b and/or the external mounting elements 324a, 324b may be fixed to the internal surface 12 (FIG. 1) or the peripheral external surfaces 14a, 14b (FIG. 1) of wall 9 defining the door opening 11 using, without limitation, screws, nails, glue, dove tail elements and any other suitable fastener for fixing the internal mounting elements 316a, 316b and/or the external mounting elements 324a, 324b to the internal surface 12 or to the peripheral external surfaces 14a, 14b. More preferably, the internal mounting elements 316a, 316b are interfacing with the internal surface 12 and the external mounting elements 324a, 324b are fixed to the peripheral external surfaces 14a, 14b.

According to an embodiment, the internal mounting elements 316a, 316b and the external mounting elements 324a, 324b may include, without limitation, a medium-density fiberboard material (i.e., MDF), a low-density fiberboard material (i.e., LDF), a high-density fiberboard material (i.e., HDF), a particle board, a wood material, a metallic material, a polymeric material, any combinations, and any other suitable material for use of the decorative foldable door frame 300 in indoor conditions or in outdoor conditions (or in both indoor and outdoor conditions).

According to another embodiment, the foldable layers 322a, 322b may include, without limitation, a thermoplastic material, a plastic material, a polymeric material, a metallic material, a linerboard material, any combinations, and any suitable material for allowing the decorative foldable door frame 300 to be folded and unfolded between a non-installed position (FIGS. 15A-15D) and an interfacing position (FIG. 16). Thus, the foldable layers 322a, 322b need to be flexible and strength such as to fold and unfolded without damage or with reduced risks of damages.

As shown in FIGS. 15A-16, the foldable layers 322a, 322b may cover the internal mounting surfaces 318a, 328a, 318b, 328b of the internal mounting elements 316a, 316b and of the external mounting elements 324a, 324b. However, it is to be noted that the foldable layers 322a, 322b may partially or totally covers the internal mounting surfaces 318a, 328a, 318b, 328b of the internal mounting elements 316a, 316b and of the external mounting elements 324a, 324b.

According to another embodiment, the foldable layers 322a, 322b may also cover the external surfaces 320a, 330a, 320b, 330b of the internal mounting elements 316a, 316b and of the external mounting elements 324a, 324b. It is to be noted that in both cases, the foldable layers 322a, 322b may be weakened at longitudinal lines (not shown) between the internal mounting element 316a and the external mounting element 324a and the internal mounting element 316b and the external mounting element 324b. In this case, the decorative foldable door frame 300 may fold and unfold to adopt any position between the non installed position (FIGS. 15A-15D) and the interfacing position (FIG. 16).

According to another embodiment, the foldable layers 322a, 322b may partially or totally cover the external surfaces 320a, 330a, 320b, 330b of the internal mounting elements 316a, 316b and of the external mounting elements 324a, 324b.

In the scenario where the foldable layers 322a, 322b cover the internal mounting surfaces 318a, 328a, 318b, 328b of the internal mounting elements 316a, 316b and the external mounting elements 324a, 324b, the foldable layers 322a, 322b may further include at least one foldable fin (i.e., or projecting portion, not shown) outwardly extending from the foldable layers 322a, 322b.

It is to be notated that, the internal mounting element 316a adjacent with the external mounting element 324a via the foldable layer 322a and the internal mounting element 316b adjacent with the external mounting element 324b via the foldable layer 322b may come into a kit for allowing a user to releasably connect them, via the mating connectors 338 and 340 of the internal mounting elements 316a, 316b.

It is to be noted that the ends of the external mounting elements 324a, 324b opposite the ends 337a, 336b with the mating connectors each include a mating connector 400, 401 for releasably connecting with a corresponding mating connector (not shown) of a decorative element (i.e., a decorative molding).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A decorative foldable frame for interfacing with a surface defining an internal surface and a peripheral external surface, the decorative foldable frame comprising:
an internal mounting element having an internal mounting surface for interfacing with the internal surface and an external surface, the internal mounting element defining a first end and a second end;
at least two external mounting elements adjacent to each one of the first and second ends of the internal mounting element, each one of the at least two external mounting elements having an internal mounting surface for interfacing with the peripheral external surface and an external surface; and
a foldable layer covering at least one of: the internal mounting surface and the external surface of the internal mounting element or the at least two external mounting elements;
wherein the foldable layer is integrally formed for allowing the decorative foldable frame to fold and unfold to adopt any position between a non-installed position and an interfacing position.

2. The decorative foldable frame of claim 1, wherein the internal mounting element comprises a first internal mounting element and a second internal mounting element, each one of the first and second internal mounting elements defining a first end and a second end opposed to the first end, the first end of the first internal mounting element further comprising a mating connector releasably connected with a corresponding mating connector on the second end of the second internal mounting element.

3. The decorative foldable frame of claim 1, wherein the internal mounting element defines a longitudinal edge and wherein at least one of the external mounting elements defines a corresponding edge for interfacing with the longitudinal edge of the internal mounting element when the decorative foldable frame adopts the interfacing position.

4. The decorative foldable frame of claim 3, wherein the longitudinal edge defines a first longitudinal edge at the first end of the internal mounting element and a second longitudinal edge at the second end of internal mounting element and further wherein two external mounting elements define a first corresponding edge for interfacing with the first longitudinal edge of the internal mounting element and a second corresponding edge for interfacing with the second longitudinal edge of the internal mounting element when the decorative foldable frame adopts the interfacing position.

5. The decorative foldable frame of claim 4, wherein the first longitudinal edge and the second longitudinal edge of the internal mounting element comprises a 45° longitudinal edge.

6. The decorative foldable frame of claim 5, wherein the first corresponding edge of a first one of the two external mounting elements and the second corresponding edge of a second one of the two external mounting elements comprise a corresponding 45° longitudinal edge for interfacing with the first and second longitudinal edges of the internal mounting element when the decorative foldable frame adopts the fixedly interfacing position.

7. The decorative foldable frame of claim 4, wherein the internal mounting element interacts with the at least two external mounting elements for creating a 90° angle.

8. The decorative foldable frame of claim 1, wherein the internal mounting element and the at least two external mounting elements comprise one of: a medium-density fiberboard material, a low-density fiberboard material, a high-density fiberboard material, a particle board, a wood material, a metallic material, a polymeric material and any combination thereof.

9. The decorative foldable frame of claim 1, wherein the foldable layer comprises a thermoplastic material, a plastic material, a polymeric material, a metallic material, a linerboard material and any combination thereof.

10. The decorative foldable frame of claim 1, wherein the foldable layer covers the internal mounting surface of the internal mounting element and the at least two external mounting elements.

11. The decorative foldable frame of claim 10, wherein the foldable layer partially covers the internal mounting surface of the internal mounting element and the at least two external mounting elements.

12. The decorative foldable frame of claim 1, wherein the foldable layer covers the external surface of the internal mounting element and the at least two external mounting elements.

13. The decorative foldable frame of claim 12, wherein the foldable layer partially covers the external surface of the internal mounting element and the at least two external mounting elements.

14. The decorative foldable frame of claim 12, wherein the foldable layer further includes at least one foldable projection portion outwardly extending from the foldable layer.

15. A decorative foldable member comprising:
an internal mounting element defining an internal interfacing surface, a first longitudinal end, a second longitudinal end and an external surface;
two external mounting elements, each one of the two external mounting elements being adjacent to the first and second longitudinal ends respectively of the internal mounting element, each one of the two external mounting elements defining an external surface and an internal interfacing surface, an interfacing surface of one of the two external mounting elements for interfacing with the internal interfacing surface of the other one of the two external mounting element; and
a foldable layer covering at least one of: the internal interfacing surface and the external surface of the internal mounting element or the two external mounting elements;
wherein the foldable layer is integrally formed for allowing the decorative foldable member to fold and unfold to adopt any position between a non-interfacing position and an interfacing position.

16. The decorative foldable member of claim 15, wherein when adopting the interfacing position, the internal interfacing surfaces of the two external mounting elements are interfacing for creating a mating connector at a distal end of the decorative foldable member to receive at least one corresponding mating connector of another member.

17. The decorative foldable member of claim 15, wherein the internal interfacing surface of the internal mounting element comprises a first internal interfacing surface and a second internal interfacing surface adjacent to the first internal interfacing surface.

18. The decorative foldable member of claim 17, wherein the two external mounting elements define a first corresponding edge on one of the two external mounting elements for totally interfacing with the first internal interfacing surface of the internal mounting element and a second corresponding edge on the other one of the two external mounting elements for interfacing with the second interfacing surface of the internal mounting element when the decorative foldable member adopts the interfacing position.

19. The decorative foldable member of claim 17, wherein the first internal interfacing surface and the second internal interfacing surface each defines a 45° longitudinal edge.

20. (canceled)

21. The decorative foldable member of claim 20, wherein the internal mounting element interacts with the two external mounting elements for creating 90° angles.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)
